(19) United States
(12) Patent Application Publication
(10) Pub. No.: US 2010/0068439 A1
(43) Pub. Date: Mar. 18, 2010

(54) POLYESTER COMPOSITION WITH IMPROVED GAS BARRIER PROPERTIES AND ARTICLES THEREOF

(75) Inventors: Phillip Andrew Bullock, Redcar Cleveland (GB); Peter John Coleman, Darlington Durham (GB); Stephen Derek Jenkins, Stokesley Cleveland (GB); Sanjay Mehta, Spartansburg, SC (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: INVISTA North aAmerica S.ar.I, Wilmington, DE (US)

(21) Appl. No.: 12/523,832

(22) PCT Filed: Jan. 31, 2008
(86) PCT No.: PCT/US2008/052593

§ 371 Date: Oct. 13, 2009

Related U.S. Application Data
(60) Provisional application No. 60/898,835, filed on Feb. 1, 2007.

(51) Int. Cl. C08L 67/00; C08K 5/10; C08K 5/12; C08K 5/15; C08K 5/1539; B32B 1/00

(52) U.S. Cl. 428/36.92; 524/599; 524/287; 524/308; 524/296; 524/112

(57) ABSTRACT

The present invention relates to a polyester composition having a liquid antiplasticizer. The composition has improved gas barrier properties with reduced degradation and plate out effects on molds and rollers. Other embodiments of the present invention disclosed herein are articles made from the composition and methods to make such articles.

This application claims the benefit of U.S. Provisional Application No. 60/898,835 filed Feb. 1, 2007.

### FIELD OF THE INVENTION

This invention relates to polyester compositions and polyester articles having improved gas barrier properties.

### BACKGROUND OF THE INVENTION

Polyesters are widely used to make containers for carbonated soft drinks, juice, water, and the like. Poor gas barrier of polyesters to oxygen and carbon dioxide, limits application of polyester for smaller sized containers for carbonated drinks, as well as for packaging oxygen sensitive products, such as beer, juice, and tea. These polyester containers are manufactured by an injection mold, stretch blow molding process. The polyester is melt injected into preforms that are subsequently stretch blow molded into containers.

Numerous technologies have been developed to improve the gas barrier properties of polyesters. For example, external or internal coatings have been developed for enhancing the gas barrier of polyester containers. These coatings add an additional processing step. Another example, multi-layered containers have been developed with a high barrier layer sandwiched between two or more polyester layers. Both of these technologies require capital investments and complicated processing that increase the cost of manufacturing the containers.

Recent developments have focused on solid additives, such as alkyl 4-hydroxybenzoates and dihydroxy naphthalene that can be incorporated into polyesters to improve their gas barrier properties. These additives are blended with the polyester at the injection molding stage. These additives are known as solid antiplasticizers.

Currently used solid antiplasticizers suffer from a loss in the polyester molecular weight during extrusion into preforms, and more importantly these small molecular weight compounds plate out on the molds used to form the preform and on the rollers used on sheets and films. The plate out on the molds can cause a change in dimensions of the mold cavities, reduced mold cooling, defects in the preforms (contamination and surface roughness), and blocking the vents in the mold. The plate out on the rollers can cause reduced roller cooling, and defects in the films/sheets (contamination and surface roughness). Frequent cleaning of the molds and rollers is therefore required with currently used solid antiplasticizers.

There exists a need to improve the gas barrier properties of polyesters in a manner that does not cause substantial degradation of the polyester and does not cause plate out during injection molding.

### SUMMARY OF THE INVENTION

In accordance with the present invention, it has now been found that liquid antiplasticizers improve the gas barrier properties of polyesters while reducing degradation and plate out effects on molds and rollers as compared to traditionally used solid antiplasticizers. Liquid anitplasticizer additive systems are also more efficient to operate and maintain due to the elimination of handling solids. The present invention includes a composition comprising a polyester and a liquid antiplasticizer. This invention also encompasses articles made from this composition and the method by which the liquid antiplasticizer is blended with the polyester.

### DETAILED DESCRIPTION OF THE INVENTION

The present invention can be characterized by a composition comprising a polyester and a liquid antiplasticizer. A liquid antiplasticizer can be a liquid or in a liquid phase at a temperature in the range of from about −30° C. to about 300° C., or from about −12° C. to about 284° C. Liquid antiplasticizers are small molecules which can penetrate into the free volume of polyesters. A liquid antiplasticizer can be at least one member selected from the group consisting of an alkyl benzoate, a substituted citrate, a substituted phthalate, an alkyl toluate and mixtures thereof. An alkyl benzoate can be, for example, methyl benzoate. A substituted citrate can be, for example, triethyl citrate. A substituted phthalate can be, for example, dimethyl phthalate. An alkyl toluate can be, for example, monoester alkyl toluate, diester alkyl toluate, propyl-p-toluate, butyl-p-toluate, pentyl-p-toluate, hexyl-p-toluate, ethylhexyl-p-toluate, isononyl-p-toluate, propylheptyl-p-toluate, isoundecyl-p-toluate and mixtures thereof. A liquid antiplasticizer can be present in a concentration of from about 0.1% by weight to about 10% by weight of said polyester, for example from about 0.2% by weight to about 10% by weight of said polyester or from about 0.4% by weight to about 5% by weight of said polyester or from about 2% by weight to about 5% by weight of said polyester.

The polyester can be polyethylene terephthalate, polyethylene naphthalate, polyethylene isophthalate, copolymers of polyethylene terephthalate, copolymers of polyethylene naphthalate, copolymers of polyethylene isophthalate, or mixtures thereof. A suitable polyester is a copolymer of polyethylene terephthalate. For example polyethylene terephthalate copolymers having less than 10% diacid component modification and/or less than 10% diol component modification, based on 100 mole % diacid component and 100 mole % diol component, can be used in this invention. Isophthalic acid, diethylene glycol and 1,4-cyclohexane dimethanol can be used as comonomers. Polyethylene terephthalate copolymers are known and commercially available as “bottle grade” polyester (PET). PET can contain additional additives such as reheat agents, acetaldehyde scavengers, UV blockers and similar additives.

The composition of the present invention can further comprise a substituted succinic anhydride, for example alkenyl succinic anhydride (ASA). The substituted succinic anhydride can be present in a concentration of from about 0.05% by weight to about 10% by weight of said polyester, for example from about 0.2% by weight to about 5% by weight of said polyester or from about 2% by weight to about 5% by weight of said polyester. The substituted succinic anhydride can be pre-reacted or mixed with a liquid antiplasticizer in a ratio of liquid antiplasticizer to substituted succinic anhydride of from 2:1 to 8.4:1. Pre-reaction of the liquid antiplasticizer and substituted succinic anhydride can be done at a temperature of from about 200° C. to about 300° C. over a period of time from about 1.5 hours to 2.5 hours.

The composition of the present invention can further comprise a chain extender, for example N,N′carbonylbiscaprolactam (CBC). The chain extender can be present in a concentration of from about 0.025% by weight to about 0.5% by weight of said polyester, for example from about 0.1% by weight to about 0.4% by weight of said polyester or from about 0.1% by weight to about 0.25% by weight of said polyester.

Another embodiment of the present invention is characterized by articles made from the composition comprising polyester and a liquid antiplasticizer. A liquid antiplasticizer can be a liquid or in a liquid phase at a temperature in the range of from about −30° C. to about 300° C., or from about −12° C. to about 284° C. Liquid antiplasticizers are small molecules which can penetrate into the free volume of polyesters. A liquid antiplasticizer can be at least one member selected from the group consisting of an alkyl benzoate, a substituted citrate, a substituted phthalate, an alkyl toluate and mixtures thereof. An alkyl benzoate can be, for example, methyl benzoate. A substituted citrate can be, for example, triethyl citrate. A substituted phthalate can be, for example, dimethyl phthalate. An alkyl toluate can be, for example, monoester alkyl toluate, di ester alkyl toluate, propyl-p-toluate, butyl-p-toluate, pentyl-p-toluate, hexyl-p-toluate, ethylhexyl-p-toluate, isononyl-p-toluate, propylheptyl-p-toluate, isoundecyl-p-toluate and mixtures thereof. A liquid antiplasticizer can be present in an amount of from about 0.1% by weight to about 10% by weight of said polyester, for example from about 0.4% by weight to about 5% by weight of said polyester or from about 2% by weight to about 5% by weight of said polyester. The polyester can be polyethylene terephthalate, polyethylene naphthalate, polyethylene isophthalate, copolymers of polyethylene terephthalate, copolymers of polyethylene naphthalate, copolymers of polyethylene isophthalate, or mixtures thereof. A suitable polyester is a copolymer of polyethylene terephthalate. A multilayer bottle can be prepared in which the middle layer contains the PET and liquid antiplasticizer, with PET as the inner and outer layer.

Yet another embodiment of the present invention is a method for making articles from the composition comprising polyester and a liquid antiplasticizer. For example, a method for reducing the gas permeability of polyester articles comprising: i) adding a liquid antiplasticizer to a polyester, ii) melting the mixture, and iii) forming an article. A liquid antiplasticizer can be a liquid or in a liquid phase at a temperature in the range of from about −30° C. to about 300° C., or from about −12° C. to about 284° C. Liquid antiplasticizers are small molecules which can penetrate into the free volume of polyesters. A liquid antiplasticizer can be at least one member selected from the group consisting of an alkyl benzoate, a substituted citrate, a substituted phthalate, an alkyl toluate and mixtures thereof. An alkyl benzoate can be, for example, methyl benzoate. A substituted citrate can be, for example, triethyl citrate. A substituted phthalate can be, for example, dimethyl phthalate. An alkyl toluate can be, for example, monoester alkyl toluate, diester alkyl toluate, propyl-p-toluate, butyl-p-toluate, pentyl-p-toluate, hexyl-p-toluate, ethylhexyl-p-toluate, isononyl-p-toluate, propylheptyl-p-toluate, isoundecyl-p-toluate and mixtures thereof. A liquid antiplasticizer can be present in this method in an amount of from about 0.1% by weight to about 10% by weight of said polyester, for example from about 0.4% by weight to about 5% by weight of said polyester or from about 2% by weight to about 5% by weight of said polyester. The method can further comprise the addition of at least one member selected from the group consisting of a substituted succinic anhydride, a chain extender and mixtures thereof to said polyester in step i).

The manufacture of PET is known to those skilled in the art, and generally comprises a melt phase followed by a solid phase polymerization to obtain a resin with an Intrinsic Viscosity (IV) of about 0.8 dl/g. The liquid antiplasticizer can be metered into the throat or at other points along the barrel of the preform injection molding extruder with the PET resin. The preforms can be stretch blow molded into bottles using commercial equipment. Improved gas barrier films can be prepared by injecting the liquid antiplasticizer into the molten polyester prior to casting the film.

As used in this specification and unless otherwise indicated the term “alkyl” used alone or as part of a larger moiety, includes straight or branched chains of at least one or two carbon atoms, as appropriate to the substituent, and up to 18 carbon atoms, for example up to ten carbon atoms or up to seven carbon atoms. The term “alkenyl”, used alone or as part of a larger moiety, includes straight or branched chains of at least two carbon atoms containing at least one carbon-carbon double bond, and up to 18 carbon atoms, for example up to ten carbon atoms or up to seven carbon atoms; or from 16 to 18 carbon atoms.

### Test Methods

Carbon dioxide permeability of films was measured using a Mocon Permatran-C, model 4/41. Tests were conducted at 23° C. and 0% RH. Prior to testing, the film samples were nitrogen conditioned for 25 hrs. After the conditioning period, testing was started using a CO₂ flow rate of 20 seem (standard cubic centimeters per minute) and N2 flow rate of 10 seem. The sample area tested was 50 cm². The CO₂ permeation rate of the sample was measured for 45 minutes and reported as cm³/m².atm.day. The system automatically corrected the transmission rate value to atmospheric barometric pressure of 760 mm Hg. Once a steady state (equilibrium) was obtained, testing was complete. The sample thickness was measured. The carbon dioxide permeability was then reported as cm³.cm/m².atm.day.

Oxygen permeability was measured using the same procedure as above with an O₂ gas stream and a Mocon Ox-Tran model 2/60.

A barrier improvement factor (BIF) is defined as the permeability of a control film, containing no liquid antiplasticizer, divided by the permeability of a film containing the liquid antiplasticizer

The haze of the preform and bottle walls was measured with a Hunter Lab Color Quest II instrument. D65 illuminant was used with a CIE 1964 10° standard observer. The haze is defined as the percent of the CIE Y diffuse transmittance to the CIE Y total transmission. The color of the preform and bottle walls was measured with the same instrument and is reported using the CIELAB color scale, L* is a measure of brightness, a* is a measure of redness (+) or greenness (−) and b* is a measure of yellowness (+) or blueness (−).

The Intrinsic Viscosity (IV) of the polymer, preform or bottle was measured according to ASTM D4603.

### EXAMPLES

### Example 1

Methyl benzoate was added to a commercial PET bottle resin (INVISTA type 1101) during preform injection molding and bottles were prepared by stretch blow molding. Sections of the bottle sidewalls were cut and the carbon dioxide permeability measured. The results are set forth in Table 1.

TABLE 1

| Methyl Benzoate | Film thickness | CO₂ permeability | |
|---|---|---|---|
| (wt. % of PET) | (mil) | (cm³ · cm/m² · atm · day) | BIF |
| 0 | 10 | 0.762 | 1.00 |
| 1.2 | 10.26 | 0.638 | 1.19 |
| 2 | 8.9 | 0.588 | 1.30 |

### Example 2

Triethyl citrate was added to a commercial PET bottle resin (INVISTA type 1101) during preform injection molding and bottles were prepared by stretch blow molding. Sections of the bottle sidewalls were cut and the oxygen permeability measured. The results are set forth in Table 2.

TABLE 2

| Triethyl citrate | Intrinsic Viscosity | O₂ permeability | |
|---|---|---|---|
| (wt. % of PET) | (IV) | (cm³ · μm/m²/day · atm) | BIF |
| 0 | 0.73 | 2492 | 1.00 |
| 1.0 | 0.69 | 2297 | 1.08 |
| 2.0 | 0.64 | 2065 | 1.20 |
| 3.0 | 0.56 | 2137 | 1.16 |

### Example 3

Dimethyl phthalate was added to a commercial PET bottle resin (INVISTA type 1101) during preform injection molding and bottles were prepared by stretch blow molding. Sections of the bottle sidewalls were cut and the oxygen permeability measured. The results are set forth in Table 3.

TABLE 3

| Dimethyl Phthalate | O₂ permeability | |
|---|---|---|
| (wt. % of PET) | (cm³ · μm/m²/day · atm) | BIF |
| 0 | 2265 | 1.00 |
| 1.0 | 1826 | 1.24 |
| 2.0 | 1896 | 1.19 |
| 3.0 | 1779 | 1.27 |
| 4.0 | 1885 | 1.20 |
| 5.0 | 1682 | 1.35 |

### Example 4

Ethylhexyl-p-toluate was added to a commercial PET bottle resin (INVISTA type 1101) during preform injection molding and bottles were prepared by stretch blow molding. Sections of the bottle sidewalls were cut and the oxygen permeability measured. The results are set forth in Table 4.

TABLE 4

| Ethylhexyl-p- | | |
|---|---|---|
| toluate | O₂ permeability | |
| (wt. % of PET) | (cm³ · μm/m²/day · atm) | BIF |
| 0 | 2351 | 1.00 |
| 1.0 | 2108 | 1.12 |
| 3.0 | 2077 | 1.13 |
| 5.0 | 2110 | 1.11 |

### Example 5

Methyl benzoate was pre-reacted with an alkenyl succinic anhydride (ASA) at a ratio of 2:1, at a temperature of 207° C. over a period of 2 hours. This premix of methyl benzoate and ASA was added to a commercial PET bottle resin (INVISTA type 1101) during preform injection molding and bottles were prepared by stretch blow molding. Sections of the bottle sidewalls were cut and the carbon dioxide permeability measured. Additionally, a chain extender, N,N′carbonylbiscaprolactam (CBC), was added in one of the samples during preform injection molding. The results are set forth in Table 5.

TABLE 5

| Methyl | | Film | CO₂ permeability | |
|---|---|---|---|---|
| Benzoate/ASA | CBC | thickness | (cm³ · cm/ | |
| (wt. % of PET) | (wt. % of PET) | (mil) | m² · atm · day) | BIF |
| 0 | 0 | 10 | 0.762 | 1.00 |
| 1.44 | 0 | 9.49 | 0.603 | 1.26 |
| 2.40 | 0 | 9.29 | 0.562 | 1.36 |
| 2.40 | 0.2 | 9.72 | 0.48 | 1.48 |
| 3.36 | 0 | 10.35 | 0.578 | 1.32 |

### Example 6—Comparative Example

A run similar to Example 1 was conducted using methyl 4-hydroxybenzoate, a solid antiplasticizer, at a 4 wt. % loading in a LASER+ bottle resin.

The preform IV, haze and L* of a control, the runs with 2 wt. % methyl benzoate, and 4 wt. % methyl 4-hydroxybenzoate were measured and compared, together with a visual observation of the plate out on the tooling. The results are set forth in Table 6.

TABLE 6

| | Loading | Preform | | | Plate out |
|---|---|---|---|---|---|
| Antiplasticizer | wt. % | IV | Haze, % | L* | on mold |
| None | — | 0.83 | 43.1 | 72.4 | None |
| Methyl benzoate | 2 | 0.79 | 51.9 | 73.5 | None |
| Methyl 4-hydroxy | 4 | 0.63 | n.m. | n.m. | Significant |
| benzoate | | | | | |

(n.m.—not measured)

There was not a significant loss in preform IV by the addition of the methyl benzoate, and the preform brightness (L*) was comparable to the control. This can be compared to the significant IV loss with methyl 4-hydroxybenzoate and the significant plate out with this solid antiplasticizer.
While the invention has been described in conjunction with specific embodiments thereof, it is evident that the many alternatives, modifications, and variations will be apparent to those skilled in the art in light of the foregoing description. Accordingly, the invention is intended to embrace all such alternatives, modifications and variations as fall within the spirit and scope of the claims.

What is claimed is:

1. A composition comprising a polyester and a liquid antiplasticizer.

2. The composition of claim 1 wherein said liquid antiplasticizer is in a liquid phase at a temperature in the range of from about −30° C. to about 300° C.

3. The composition of claim 1 wherein said liquid antiplasticizer is in a liquid phase at a temperature in the range of from about −12° C. to about 284° C.

4. The composition of claim 1 wherein said liquid antiplasticizer comprises at least one member selected from the group consisting of an alkyl benzoate, a substituted citrate, a substituted phthalate, an alkyl toluate and mixtures thereof.

5. The composition of claim 4 wherein said liquid antiplasticizer is an alkyl benzoate.

6. The composition of claim 5 wherein said alkyl benzoate is methyl benzoate.

7. The composition of claim 4 wherein said liquid antiplasticizer is a substituted citrate.

8. The composition of claim 7 wherein said substituted citrate is triethyl citrate.

9. The composition of claim 4 wherein said liquid antiplasticizer is a substituted phthalate.

10. The composition of claim 9 wherein said substituted phthalate is dimethyl phthalate.

11. The composition of claim 4 wherein said liquid antiplasticizer is an alkyl toluate.

12. The composition of claim 11 wherein said alkyl toluate is selected from the group consisting of monoester alkyl toluate, diester alkyl toluate, propyl-p-toluate, butyl-p-toluate, pentyl-p-toluate, hexyl-p-toluate, ethylhexyl-p-toluate, isononyl-p-toluate, propylheptyl-p-toluate, isoundecyl-p-toluate and mixtures thereof.

13. The composition of claim 1 wherein said polyester is selected from the group consisting of polyethylene terephthalate, polyethylene naphthalate, polyethylene isophthalate, copolymers of polyethylene terephthalate, copolymers of polyethylene naphthalate, copolymers of polyethylene isophthalate and mixtures thereof.

14. The composition of claim 13 wherein said polyester is a copolymer of polyethylene terephthalate.

15. The composition of claim 1 wherein said liquid antiplasticizer is present in an amount of from about 0.1% by weight to about 10% by weight of said polyester.

16. The composition of claim 15 wherein said liquid antiplasticizer is present in an amount of from about 0.4% by weight to about 5% by weight of said polyester.

17. The composition of claim 16 wherein said liquid antiplasticizer is present in an amount of from about 2% by weight to about 5% by weight of said polyester.

18. The composition of claim 1 further comprising a substituted succinic anhydride.

19. The composition of claim 18 wherein said substituted succinic anhydride is an alkenyl succinic anhydride.

20. The composition of claim 18 wherein said substituted succinic anhydride is present in a concentration of from about 0.05% by weight to about 10% by weight of said polyester.

21. The composition of claim 1 further comprising a chain extender.

22. The composition of claim 21 wherein said chain extender is N,N′carbonylbiscaprolactam.

23. The composition of claim 21 wherein said chain extender is present in a concentration of from about 0.025% by weight to about 0.5% by weight of said polyester.

24. An article comprising the composition of claim 1.

25. The article of claim 24 wherein said article comprises a sheet, film or container.

26. A method for reducing the gas permeability of polyester articles comprising: i) adding a liquid antiplasticizer to a polyester, ii) melting the mixture, and iii) forming an article.

27. The method of claim 26 further comprising the addition of at least one member selected from the group consisting of a substituted succinic anhydride, a chain extender and mixtures thereof to said polyester in step i).
